(19) United States
(12) Patent Application Publication
(10) Pub. No.: US 2011/0010840 A1
(43) Pub. Date: Jan. 20, 2011

(54) DUAL-HEAD SHOWER ASSEMBLY

(76) Inventor: JEFF PAUL, Mandan, ND (US)

Correspondence Address: LAW OFFICE OF JERRY D. HAYNES , P.A, P.O. Box 350392, Fort Lauderdale, FL, 33335, US

(21) Appl. No.: 12/504,310

(22) Filed: Jul. 16, 2009

(51) Int. Cl. A47K 3/28; B23P 17/04

(52) U.S. Cl. 4/601; 29/428

(57) ABSTRACT

The present invention relates to a dual shower head assembly and a method of installing where the head assembly includes: a first shower head; a mechanism to split water supply into the first shower head; a second shower head, where the second shower head is opposed to the first shower head; a water supply pipe connector, where said pipe connector connects the second shower head to the means to split the water supply; and a mechanism to hang a shower curtain on the shower head assembly. The pipe connector may provide the mechanism to hang a shower curtain. In one particular embodiment, a splitter connected above the first shower head provides the mechanism to split the water supply.

### BACKGROUND OF THE INVENTION

1. Field of Invention

The present invention relates to a dual-head shower assembly that includes a means to support a shower curtain.

2. Description of Related Art

Many designs and configurations have been developed for bathtubs and showers over the years. Various showerheads have been developed in order to enhance the experience for the user. Some showerheads attempt to divert water in various manners to increase the efficiency of the shower and to provide the user with the greater coverage area. Furthermore some showerhead assemblies include multiple showerheads that increase coverage and the overall experience for the user.

U.S. Pat. No. 3,121,235 discloses a multiple-head shower assembly that includes up to four showerheads assembled along a vertical configuration where two showerheads provide upper streams of water and two additional showerheads below the centerline thereof provide lower streams of water. U.S. Pat. No. 3,822,826 discloses an attachment device that converts a single showerhead to a dual opposed showerhead assembly where the showering is provided at each side of the shower enclosure.

U.S. Pat. No. 5,564,139 discloses a showerhead assembly for simultaneously showering the front and back portions of a person's body without the person receiving the force of the shower spray directed toward their face. The showerhead assembly of the '139 patent includes an orientation where showerheads are separated with respect to the overhead supply line.

U.S. Pat. No. 6,415,461 discloses an adjustable shower assembly that provides multiple showerheads at various locations without the need for additional plumbing. The adjustable shower system of the '461 patent includes a plurality of connecting tubes and suction cups provided to maneuver the position of the showerheads as desired by the user.

### SUMMARY OF THE INVENTION

The present invention relates to a dual shower head assembly comprising: a first shower head; a means to split water supply into the first shower head; a second shower head, where the second shower head is opposed to the first shower head; a water supply pipe connector, where said pipe connector connects the second shower head to the means to split the water supply; and a means to hang a shower curtain on the shower head assembly. The pipe connector may provide the means to hang a shower curtain. In one particular embodiment, a splitter connected above the first shower head provides the means to split the water supply.

The present invention further provides a method of installing a dual shower head assembly comprising the steps of: splitting the water supply of a first shower head on a first side wall of a shower enclosure; diverting the split water supply to a second shower head on a second side wall of a shower enclosure; and supplying a means to hang a shower curtain.

### BRIEF DESCRIPTION OF DRAWINGS

FIG. 1 shows a dual-head shower assembly according to the present invention.

### DETAILED DESCRIPTION

The present invention provides a dual-head shower assembly that directs water to the front and back portions of a shower enclosure. The shower assembly according to the present invention enables the user to receive water in both directions without the necessity of turning while in the shower. Water directed from the one end of the shower assembly may be utilized as one side of water spray with an opposite side water spray at the opposite end of the shower enclosure. In addition to providing a dual shower head, the piping associated with the dual shower heads is further used as a means to hang shower curtains to enclose the shower enclosure.

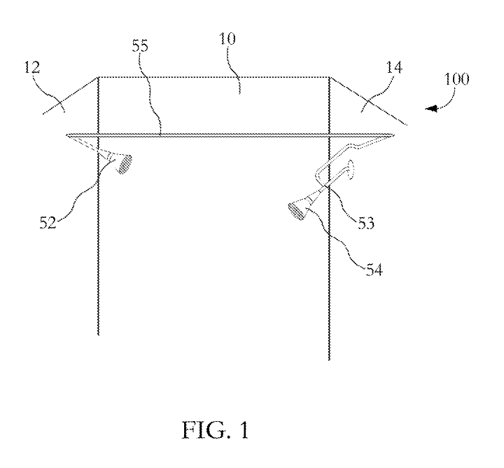

As depicted in FIG. 1, the dual shower head assembly according to the present invention includes shower heads 52, 54. As noted Shower head 54 directs water supply in one direction and Shower head 52 is positioned at the opposite end of the shower enclosure and directs water in the opposite direction. A Connector 53 splits the water supply directed to Showerhead 54 toward Showerhead 52. The water supply to Showerhead 52 flows through Piping 55. As noted in the FIG. 1, Piping 55 is directed toward the outer edge of the shower enclosure and provides a means for a hanging of a shower curtain to enclose the shower enclosure. The shower enclosure includes two opposite walls 12, 14 with a sidewall 10.

The Dual Shower Assembly 100 provides a means to supply water into a shower enclosure but also includes a means to hang a shower curtain. The angle of water spray may be slightly adjustable for each Shower head 52, 54. The shower head Assembly 100 includes a means to divert water from the main shower head 54 through a curtain rod/pipe to the opposite Showerhead 52. The design of the showerhead assembly provides a functional curtain rod while supplying water through a dual headed shower assembly. The shower assembly according to the present invention may be utilized to easily upgrade a conventional showerhead with the insertion of the splitter and the additional piping for the opposite showerhead. The installation of the showerhead assembly does not require any additional damage to the existing shower walls and eliminates the need for a curtain rod.

What is claimed is:

1. A dual shower head assembly comprising:
a. a first shower head;
b. a means to split water supply into the first shower head;
c. a second shower head, where the second shower head is opposed to the first shower head;
d. a water supply pipe connector, where said pipe connector connects the second shower head to the means to split the water supply; and
e. a means to hang a shower curtain on the shower head assembly.

2. The dual shower head assembly according to claim 1, wherein the pipe connector provides the means to hang a shower curtain.

3. The dual shower head assembly according to claim 1, wherein a splitter connected above the first shower head provides the means to split the water supply.

4. The dual shower head assembly according to claim 1, where the first shower head directs water in a first direction and the second shower head directs water in an opposite direction.

5. The dual shower head assembly according to claim 1, where the first shower head is positioned on a first side wall of a shower enclosure, and the second shower head is positioned on a second side wall opposite to the first side wall.

6. The dual shower head assembly according to claim 1, where spray angle of the first shower head and the second shower head may be adjusted.

7. A method of installing a dual shower head assembly comprising the steps of:
a. splitting the water supply of a first shower head on a first side wall of a shower enclosure;
b. diverting the split water supply to a second shower head on a second side wall of a shower enclosure; and
c. supplying a means to hang a shower curtain.

8. The method of installing a dual shower head assembly according to claim 7, further comprising the step of:
a. using a pipe connector to supply the split water to the second shower head, where said pipe connector further provides the means to hang a shower curtain.
